(19) United States
(12) Patent Application Publication
(10) Pub. No.: US 2024/0193521 A1
(43) Pub. Date: Jun. 13, 2024

(54) FUTURE EVALUATION DEVICE AND FUTURE EVALUATION METHOD

(71) Applicant: HONDA MOTOR CO., LTD., Tokyo (JP)

(72) Inventors: Masato OKUBO, Tokyo (JP); Eriko YAMAMOTO, Tokyo (JP)

(21) Appl. No.: 18/527,377

(22) Filed: Dec. 4, 2023

(30) Foreign Application Priority Data
Dec. 12, 2022 (JP) 2022-197858

(51) Int. Cl. G06Q 10/0637

(52) U.S. Cl. CPC G06Q 10/06375

(57) ABSTRACT

The future evaluation device includes a visit detection unit that detects departure facilities of a plurality of moving objects and a visit to a facility different from each departure facility, a map information storage unit that stores facility information including category information and location information on a facility, a comparative data information storage unit that stores, for the facility different from each departure facility, the number of previous visits of each moving object to the facility according to the category of departure facility as comparative data information, a prediction condition receiving unit that receives, as a user-specified facility, information on a facility specified by a user from the facility information, and an evaluation unit that creates predictive index information on the future of the user-specified facility from a proportion change based on comparison between the number of visits according to the category of departure facility and the comparative data information.

This application is based on and claims the benefit of priority from Japanese Patent Application No. 2022-197858, filed on 12 Dec. 2022, the content of which is incorporated herein by reference.

### BACKGROUND OF THE INVENTION

### Field of the Invention

The present invention relates to a future evaluation device and a future evaluation method for predicting the future of a facility.

### Related Art

A technique of predicting corporate performance has been developed.

For example, Japanese Patent No. 6994490 discloses, as a system for evaluating the future of a user-specified facility, a technique of creating, for a moving vehicle having visited the user-specified facility, predictive index information on the future of the user-specified facility based on comparison between the number of visits in a first predetermined period and the number of visits in a second predetermined period different from the first predetermined period.

### CITATION LIST

### Patent Document

Patent Document 1: Japanese Patent No. 6994490

### SUMMARY OF THE INVENTION

However, in the technique described in Japanese Patent No. 6994490, the number of visits only in the predetermined period influencing corporate performance is taken, and for this reason, a causal relationship with the corporate performance is ambiguous in some cases.

For this reason, the corporate performance prediction is inaccurate in some cases.

The present invention is intended to provide a future evaluation device and a future evaluation method for predicting the future of, e.g., a company which is the above-described facility using only objective and observable data.
(1) A future evaluation device (e.g., later-described future evaluation device 30) of the present invention includes a visit detection unit (e.g., later-described visit detection unit 312) configured to detect departure facilities of a plurality of moving objects and a visit to a facility different from each departure facility, a map information storage unit (e.g., later-described map information storage unit 321) configured to store facility information including category information and location information on a facility, a comparative data information storage unit (e.g., later-described comparative data information storage unit 324) configured to store, for the facility different from each departure facility, the number of previous visits of each moving object to the facility according to the category of departure facility as comparative data information, a prediction condition receiving unit (e.g., later-described prediction condition receiving unit 314) configured to receive, as a user-specified facility, information on a facility specified by a user from the facility information, and an evaluation unit (e.g., later-described evaluation unit 315) configured to create, for a moving object having visited the user-specified facility, predictive index information on the future of the user-specified facility from a proportion change based on comparison between the number of visits according to the category of departure facility and the comparative data information.

According to (1) above, the future of, e.g., a company which is the facility can be predicted using only objective and observable data.
(2) The future evaluation device according to (1) further includes a calendar information storage unit configured to store information on a calendar. The evaluation unit may create the predictive index information on the future of the user-specified facility based on comparison between the number of visits of the moving object in a first predetermined period of the calendar according to the category of departure facility and the comparative data information in a second predetermined period different from the first predetermined period.

According to (2) above, the future of, e.g., a company which is the facility can be more accurately predicted.
(3) In the future evaluation device according to (1) or (2), the evaluation unit may create predictive index information display data in a display form comparable based on a change in the proportion of the category information on each departure facility.

According to (3) above, the future of, e.g., a company which is the facility can be more accurately predicted.
(4) In the future evaluation device according to (1) or (2), the category information on the facility in the map information storage unit may be information on a business category, and in a case where the category information on each departure facility includes no information on the business category, the evaluation unit may determine the facility as a residence and does not use the category information for creation of the predictive index information.

According to (4) above, a vehicle used by a commuter is excluded so that the future of, e.g., a company can be more accurately predicted.
(5) The future evaluation method of the present invention is a future evaluation method performed by a computer including a map information storage unit (e.g., later-described map information storage unit 321) configured to store facility information including category information and location information on a facility. The method includes detecting departure facilities of a plurality of moving objects and a visit to a facility different from each departure facility, storing, for the facility different from each departure facility, the number of previous visits of each moving object to the facility according to the category of departure facility as comparative data information, receiving, as a user-specified facility, information on a facility specified by a user from the facility information, and creating, for a moving object having visited the user-specified facility, predictive index information on the future of the user-specified facility from a proportion change based on comparison between the number of visits according to the category of each departure facility and the comparative data information.

According to (5) above, advantageous effects similar to those of the future evaluation device of (1) above are provided.

According to the present invention, the future of, e.g., a company which is the above-described facility can be predicted using only the objective and observable data.

### BRIEF DESCRIPTION OF THE DRAWINGS

FIG. 1 is a block diagram showing a basic configuration of an entire future evaluation system in an embodiment of the present invention;

FIG. 2 is a functional block diagram showing a functional configuration of an onboard navigation device in the embodiment of the present invention;

FIG. 3 is a functional block diagram showing a functional configuration of a mobile terminal in the embodiment of the present invention;

FIG. 4 is a functional block diagram showing a functional configuration of a user terminal in the embodiment of the present invention;

FIG. 5 is a functional block diagram showing a functional configuration of a future evaluation device in the embodiment of the present invention;

FIG. 6 is a view showing one example of moving vehicle parking data in the embodiment of the present invention;

FIG. 7 is a view showing one example of a relationship between departure facilities and a specified facility in the embodiment of the present invention;

FIG. 8 is a view showing one example of predictive index information in the embodiment of the present invention;

FIG. 9 is a flowchart showing basic operation in processing of updating the moving vehicle parking data in the embodiment of the present invention; and

FIG. 10 is a flowchart showing basic operation when the predictive index information on a future is created in the embodiment of the present invention.

### DETAILED DESCRIPTION OF THE INVENTION

Hereinafter, one embodiment of a future evaluation system of the present invention will be described with reference to the drawings.

### <Entire Configuration of Future Evaluation System 1>

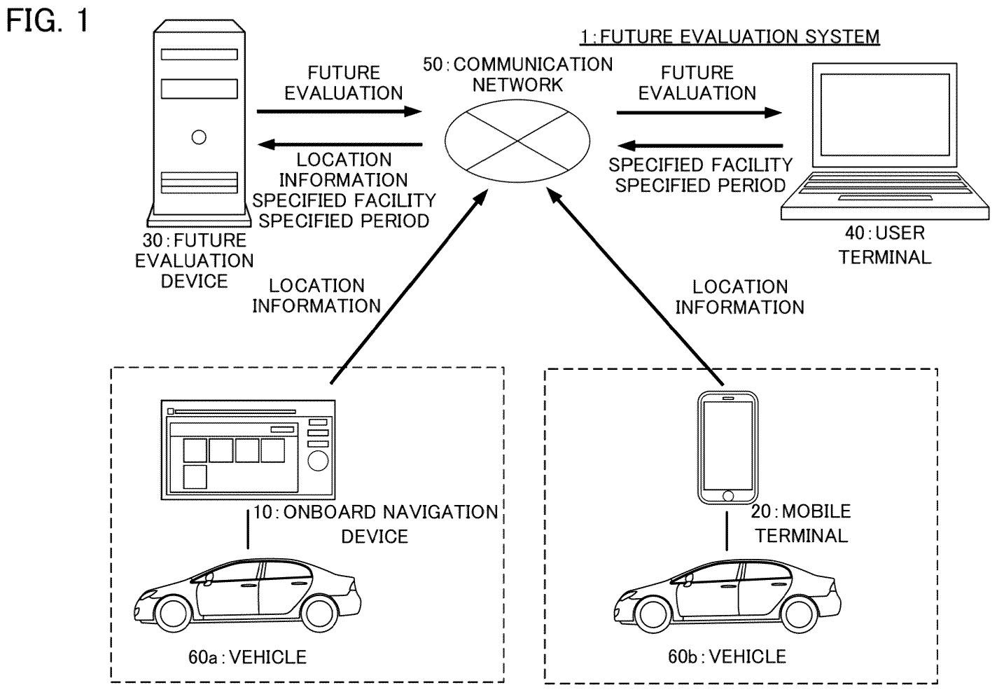

First, the outline of a future evaluation system 1 according to one embodiment of the present invention will be described. FIG. 1 shows an entire configuration of the future evaluation system 1.

As shown in FIG. 1, the future evaluation system 1 includes an onboard navigation device 10, a mobile terminal 20, a future evaluation device 30, a user terminal 40, and a communication network 50. Note that the future evaluation device 30 will be described herein as one including floating car data (FCD) collection means and moving vehicle parking data updating means, but the present invention is not limited thereto. The FCD collection means and the moving vehicle parking data updating means may be configured as devices (e.g., FCD server) different from the future evaluation device 30, and may be communicably connected to the future evaluation device 30 directly or via a network.

These devices and terminals are communicably connected to each other via the communication network 50. Note that in the figure, information to be transmitted to and received from these devices and terminals is also shown, but these types of information are merely one example. In the present embodiment, information other than that shown in the figure may be transmitted and received.

A moving object means, for example, a later-described moving vehicle, a user moving with carrying the mobile terminal 20, or a moving user. Note that in this embodiment, a moving vehicle such as a vehicle 60a including the onboard navigation device 10 or a vehicle 60b having the user carrying the mobile terminal 20 thereon will be described as an example of the moving object.

In the figure, one pair of onboard navigation device 10 and vehicle 60a and one pair of mobile terminal 20 and vehicle 60b are shown, but the number of each of these pairs is not particularly limited. In description below, in a case where the vehicle 60a equipped with the onboard navigation device 10 and the vehicle 60b having the user using the mobile terminal 20 thereon are not distinguished from each other in description, such a vehicle will be merely referred to as a “vehicle 60” with no trailing alphabet. The vehicle 60 means movement means such as a four-wheeled automobile, a three-wheeled automobile, a two-wheeled automobile, or a bicycle.

The onboard navigation device 10 is a device that performs navigation (route guidance) for the user on the vehicle 60a. The onboard navigation device 10 guides a route from a current location to a destination based on a user's request. Moreover, the onboard navigation device 10 also has a function of measuring location information (i.e., location information on the vehicle 60a) on the onboard navigation device 10. The location information measured by the onboard navigation device 10 is transmitted as necessary to the future evaluation device 30 together with moving vehicle identification information for identifying the vehicle 60a.

The onboard navigation device 10 may be implemented as a car navigation device installed on the vehicle 60a which is the moving vehicle or a portable navigation device (PND) installed in a simple manner on the vehicle 60a which is the moving vehicle. Alternatively, the onboard navigation device 10 may be implemented as electronic equipment with a predetermined application installed, such as a smartphone.

The mobile terminal 20 is a mobile terminal to be used by the user on the vehicle 60b. As in the above-described onboard navigation device 10, the mobile terminal 20 has a function of measuring location information (i.e., location information on the vehicle 60b) on the mobile terminal 20. As in the location information measured by the onboard navigation device 10, the location information measured by the mobile terminal 20 is transmitted as necessary to the future evaluation device 30 together with moving vehicle identification information for identifying the vehicle 60b. Note that the moving vehicle identification information may be acquired from the vehicle 60b by the mobile terminal 20 or identification information on the mobile terminal 20 itself may be taken as the moving vehicle identification information.

The mobile terminal 20 may be implemented as a smartphone, a mobile phone, a tablet terminal, a laptop computer, or other types of mobile electronic equipment with a predetermined application installed.

In the present embodiment, a case where the visit of the moving vehicle to a facility is detected based on FCD which is the moving vehicle location information collected from, e.g., the onboard navigation device 10 and the mobile terminal 20 will be described as an example.

The future evaluation device 30 is a device that performs, as processing unique to the present embodiment, analysis of the future of, e.g., a company based on various types of information such as the location information on each vehicle 60 which is the moving vehicle.

Thus, the future evaluation device 30 includes, for example, a map information storage unit 321 that stores facility information including category information and location information on a plurality of facilities. Based on the floating car data (FCD) which is the moving vehicle location information collected from, e.g., the onboard navigation device 10 and the mobile terminal 20, the future evaluation device 30 may calculate, for each facility including, e.g., a service office of a company, parking information (hereinafter also referred to as “moving vehicle parking data”) indicating that the moving vehicle 60 has been parked at a parking area of such a facility, and may make a database of such information.

Here, the information (moving vehicle parking data) indicating parking of the moving vehicle 60 at a specified facility corresponds to a facility ID for a parking area of the specified facility, and includes date and time (also referred to as “entry time”) at which the moving vehicle 60 has entered the parking area of the specified facility, date and time (also referred to as “exit time”) at which the moving vehicle 60 has left the parking area of the specified facility, the parking time of the moving vehicle 60, and the movement route of the moving vehicle 60 to the specified facility. Note that each moving vehicle is identified by an identification ID for the moving vehicle 60.

Based on the moving vehicle parking data, the future evaluation device 30 determines whether or not the moving vehicle 60 parked at the parking area of the specified facility falls into the category of a visit to the specified facility. Specifically, for example, in a case where initial location information on the movement route of the moving vehicle 60 in the moving vehicle parking data, i.e., the departure location of the moving vehicle 60, matches location information on a facility (departure facility) different from the specified facility, it may be determined that the user of the moving vehicle 60 is a visitor of the specified facility.

With this configuration, the future evaluation device 30 can detect, for example, the moving vehicle 60 having visited the facility specified by the user in a specified predetermined period. Moreover, the future evaluation device 30 can calculate, based on the moving vehicle parking data, the number of moving vehicles 60 having visited the specified facility (i.e., the number of visits to the specified facility) in the specified predetermined period according to the category of departure facility.

For the moving vehicle 60 having visited the facility specified by the user, the future evaluation device 30 calculates, with reference to the moving vehicle parking data, the number of visits to the specified facility in a first predetermined period according to the category of departure facility. The future evaluation device 30 may create predictive index information on the future of the specified facility from a proportion change based on comparison between the calculated number of visits in the first predetermined period according to the category of departure facility and the number of visits in a previous second predetermined period different from the first predetermined period according to the category of departure facility. Here, the predictive index information is, for example, information indicating positive, negative, or neutral.

For example, the first predetermined period is set as an arbitrary period (e.g., one month of November, 2022) specified by the user, and the second predetermined period is set as another previous period (e.g., one month of October, 2022 or November, 2021). With these settings, the number of visits to the specified facility according to the category of departure facility such as a company is clarified so that the future of the specified facility can be predicted. The future evaluation device 30 may check the proportion change based on comparison between the number of visits in the first predetermined period according to the category of departure facility and the number of visits in the second predetermined period according to the category of departure facility, thereby creating the predictive index information (e.g., information indicating positive, negative, or neutral) on the future of the specified facility.

Specifically, for example, in a case where the specified facility is a manufacturing facility and the percentage of the number of visits in the first predetermined period has increased as compared to the percentage of the number of visits in the second predetermined period when the category of departure facility is, e.g., a component manufacturer, the future evaluation device 30 may determine the future of the specified facility as positive.

The number of visits according to the category of departure facility is calculated taking service offices of a plurality of companies falling into a particular business category (category) as the specified facility, so that the future of such a business category can be predicted based on the calculated number.

The user terminal 40 is a terminal to be operated by the user, and is also a terminal that communicates with the future evaluation device 30 to acquire and make an inquiry about the predictive index information on the future.

The future evaluation device 30 and the user terminal 40 as described above may be implemented in such a manner that software for implementing the present embodiment is incorporated into a server device or a personal computer, for example.

The communication network 50 is implemented as a network such as the Internet or a mobile telephone network or a combination thereof. Part of the network (e.g., between the future evaluation device 30 and the user terminal 40) may include a local area network (LAN).

Described above is the outline of the future evaluation system 1 according to one preferred embodiment of the present invention.

Next, each device will be described in detail.

### <Functional Blocks Included in Onboard Navigation Device 10>

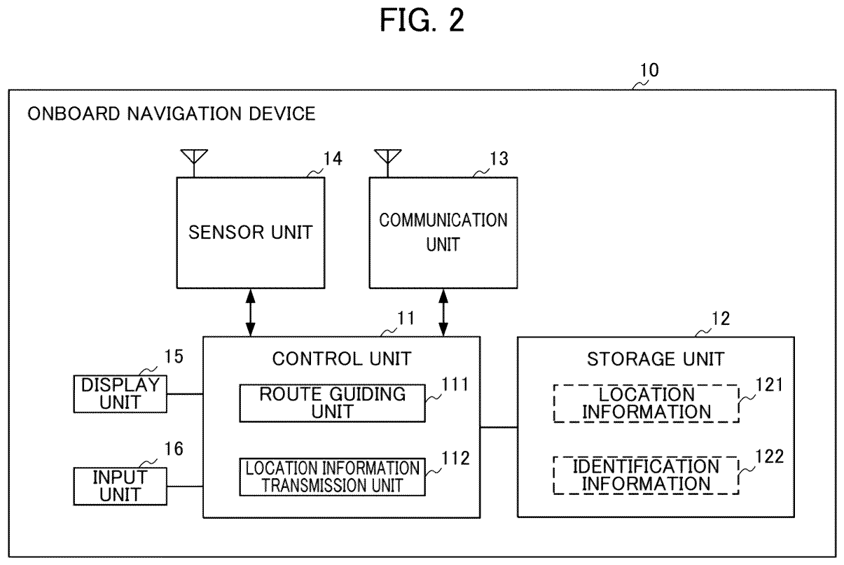

First, functional blocks included in the onboard navigation device 10 will be described with reference to a block diagram of FIG. 2.

Here, the onboard navigation device 10 is supplied with power from the vehicle 60a, and the user on the vehicle 60a turns on (starts an engine) an ignition switch of the vehicle 60a to automatically start the onboard navigation device 10. The onboard navigation device 10 is operated until the user on the vehicle 60a turns off (stops the engine) the ignition switch of the vehicle 60a.

As shown in FIG. 2, the onboard navigation device 10 includes a control unit 11, a storage unit 12, a communication unit 13, a sensor unit 14, a display unit 15, and an input unit 16.

The control unit 11 includes an arithmetic processing device such as a microprocessor, and controls each component forming the onboard navigation device 10. Details of the control unit 11 will be described later.

The storage unit 12 includes, e.g., a semiconductor memory, and stores each program such as a control program called firmware or an operating system, a program for performing route guide processing, and a program for performing location information transmission processing on the future evaluation device 30 and various other types of information such as map information. In the figure, location information 121 and moving vehicle identification information 122 which are information particularly on the location information transmission processing are shown as the information stored in the storage unit 12.

The location information 121 is location information (i.e., location information on the vehicle 60a) measured on the onboard navigation device 10 by the later-described sensor unit 14. The location information 121 includes not only information indicating a measurement location, but also the time of measurement.

The moving vehicle identification information 122 is information for identifying the onboard navigation device 10. For example, a manufacturing number uniquely assigned to the onboard navigation device 10 may be used as the moving vehicle identification information 122. In addition, a telephone number assigned to a subscriber identity module (SIM) inserted into the communication unit 13 to connect the communication unit 13 to the communication network 50 which is a network such as a mobile telephone network may be used as the moving vehicle identification information 122. Further, a vehicle identification number (VIN) or a license plate number uniquely assigned to the vehicle 60a may be used as the moving vehicle identification information 122.

Each piece of information stored in the storage unit 12 may be stored in advance in the storage unit 12, or may be downloaded as necessary from, e.g., a server device (not shown) connected to the communication network 50.

Alternatively, the information may be corrected as necessary according to, e.g., user input.

The communication unit 13 includes, e.g., a digital signal processor (DSP), and implements wireless communication with other devices (e.g., future evaluation device 30) via the communication network 50 in accordance with a standard such as long term evolution (LTE), 4th Generation (4G), 5th Generation (5G), or Wi-Fi (registered trademark). For example, the communication unit 13 is used for transmitting, by a later-described location information transmission unit 112, the location information 121 and the moving vehicle identification information 122 stored in the storage unit 12 to the future evaluation device 30 (specifically, e.g., later-described FCD collecting unit 310). Note that the data to be exchanged between the communication unit 13 and the other devices is not particularly limited, and information other than the location information 121 and the moving vehicle identification information 122 may be exchanged.

The sensor unit 14 includes, for example, a global positioning system (GPS) sensor, a gyroscope sensor, and an acceleration sensor. The sensor unit 14 has the function of location detection means that detects the location information, and receives a GPS satellite signal from the GPS sensor to measure the location information (latitude and longitude) on the onboard navigation device 10. Measurement by the sensor unit 14 is performed in a predetermined time interval (e.g., an interval of three seconds) as described above. The measured location information is stored as the location information 121 in the storage unit 12.

Note that for the sensor unit 14, the accuracy of measurement of the location information on the onboard navigation device 10 can be further enhanced based on an angular speed measured by the gyroscope sensor or an acceleration measured by the acceleration sensor.

In a case where it is difficult or impossible to perform GPS communication, the sensor unit 14 may use an assisted global positioning system (AGPS) communication and calculate the location information on the onboard navigation device 10 based on base station information acquired from the communication unit 13.

The display unit 15 includes a display device such as a liquid crystal display or an organic electroluminescence panel. The display unit 15 displays an image in response to an instruction from the control unit 11. The information to be displayed on the display unit 15 includes, for example, the current location of the onboard navigation device 10, map information on the periphery of the current location of the onboard navigation device 10 read from map information, a destination set by the user, meeting information notified from other onboard navigation devices 10, route information, and various user interfaces.

The input unit 16 includes an input device (not shown) such as a physical switch called a numeric keypad or a touch panel provided on a display surface of the display unit 15. A signal from the input unit 16 based on operation input such as pressing of the numeric keypad by the user or touch of the touch panel by the user is output to the control unit 11 so that user operation such as selection operation or map scaling operation can be implemented.

Note that although not shown in the figure, the input unit 16 may further include, e.g., a speaker and a microphone.

The speaker outputs sound to a driver, and the microphone collects, e.g., sound from the driver.

With this configuration, the information can be output via sound from the speaker, the driver can make various selections by sound input via the microphone, or an instruction can be input to the control unit 11 by a sound recognition technique.

Next, the details of the control unit 11 will be described. The control unit 11 includes a microprocessor having, e.g., a central processing unit (CPU), a random access memory (RAN), a read only memory (ROM), and an input/output (I/O). The CPU executes each program read from the ROM or the storage unit 12. Upon such execution, the CPU reads information from the RAM, the ROM, and the storage unit 12, writes information in the RAM and the storage unit 12, and exchanges a signal with the communication unit 13, the sensor unit 14, the display unit 15, and the input unit 16. In this manner, the processing in the present embodiment is implemented by cooperation of hardware and software (program).

The control unit 11 includes, as functional blocks, a route guiding unit 111 and the location information transmission unit 112.

The route guiding unit 111 is a component that performs processing of guiding a route to a destination input or selected by the user, such as a facility.

The processing of guiding the route to the destination is equivalent to route guide processing in a general car navigation system. That is, the route guiding unit 111 may generate a map to the destination based on the map information (not shown) stored in the storage unit 12, and on the display unit 15, displays the current location of the onboard navigation device 10 measured by the sensor unit 14, the location of the destination, and information on the route to the destination such that such information is superimposed on the map. In this manner, the route guiding unit 111 can guide the route. In this case, sound for the route guidance may be further output from the not-shown speaker. In addition, e.g., information on road congestion or weather information may be acquired by communication via the communication unit 13, and such acquired information may be used for the route guide processing.

Note that the processing of guiding the route to the destination is well-known by those skilled in the art, and for this reason, further detailed description thereof will be omitted. Moreover, the map information for the route guide processing is also well-known by those skilled in the art, and for this reason, further detailed description thereof will be omitted.

The location information transmission unit 112 is a component that transmits, via wireless communication using the communication unit 13, the location information 121 and the moving vehicle identification information 122 stored in the storage unit 12 to the future evaluation device 30 (FCD collecting unit 310).

The location information transmission unit 112 periodically transmits the location information 121 and the moving vehicle identification information 122 to the future evaluation device 30 (FCD collecting unit 310) until the user on the vehicle 60a turns off (stops the engine) the ignition switch of the vehicle 60a after having automatically started the onboard navigation device 10 by turning on (starting the engine) the ignition switch of the vehicle 60a. For example, such transmission is performed in real time every time the sensor unit 14 measures the location in a predetermined time interval (e.g., an interval of three seconds). Transmission to the future evaluation device 30 (FCD collecting unit 310) is not necessarily performed in real time, and plural pieces of information may be collectively transmitted at once (e.g., the location information 121 and the moving vehicle identification information 122 updated in an interval of three seconds in three minutes are collectively transmitted). That is, so-called burst transmission may be performed. The length of the predetermined time interval and determination on whether to transmit the information in real time or by the burst transmission may be arbitrarily set according to, e.g., environment to which the present embodiment is applied.

By the real-time transmission or the burst transmission as described above, the location information transmission unit 112 transmits, to the future evaluation device 30, the location information 121 measured by the sensor unit 14 for specifying the movement route of the vehicle 60a and the moving vehicle identification information 122.

In this case, a location specified from the location information 121 measured immediately after the onboard navigation device 10 has been automatically started by turning on (starting the engine) the ignition switch may be transmitted as an initial vehicle location, i.e., a departure location, to the future evaluation device 30 (FCD collecting unit 310). Further, a location specified from the location information 121 measured immediately before the ignition switch is turned off (the engine is stopped) may be transmitted as a final vehicle location, i.e., a parking location, to the future evaluation device 30 (FCD collecting unit 310).

In this case, start information indicating that the location information 121 indicates the departure location or stop information indicating that the location information 121 indicates the parking location may be added to the location information 121, and thereafter the location information 121 may be transmitted to the future evaluation device 30 (FCD collecting unit 310). For example, the location information 121 may be transmitted with a flag, which indicates the start information, of 1, or may be transmitted with a flag, which indicates the stop information, of 1. Note that the location information 121 (i.e., parking location) measured immediately before the ignition switch is turned off (the engine is stopped) may be transmitted when the onboard navigation device 10 is re-started by turning on the ignition switch (starting the engine).

In the case of performing the burst transmission, if the route guiding unit 111 determines that the vehicle 60a has arrived the destination (e.g., certain facility), the location information transmission unit 112 may switch the transmission to the real-time transmission. With this configuration, a situation can be prevented, in which the ignition switch is turned off (the engine is stopped) before the location information 121 indicating the parking location is transmitted and after the vehicle 60a has arrived the certain facility and the location information 121 indicating the destination such as the facility is not transmitted to the future evaluation device 30 (FCD collecting unit 310).

### <Functional Blocks Included in Mobile Terminal 20>

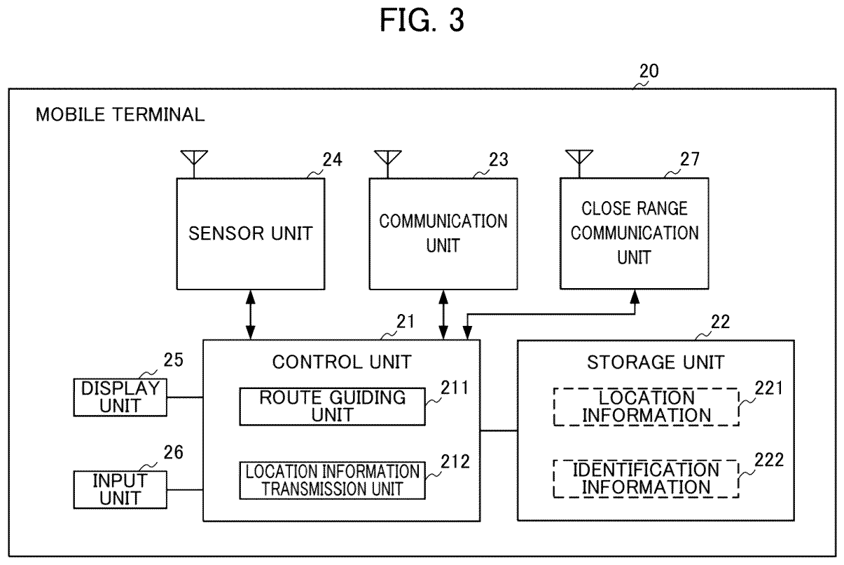

Next, functional blocks included in the mobile terminal 20 will be described with reference to a block diagram of FIG. 3.

Although the above-described onboard navigation device 10 is supplied with power from the vehicle 60a, the mobile terminal 20 is supplied with power from a battery (not shown) included in the mobile terminal 20 itself. Note that the mobile terminal 20 may be supplied with power from, e.g., a cigarette lighter socket of the vehicle 60b in order to charge the battery.

As shown in FIG. 3, the mobile terminal 20 includes a control unit 21, a storage unit 22, a communication unit 23, a sensor unit 24, a display unit 25, an input unit 26, and a close range communication unit 27.

Here, the control unit 21, the storage unit 22, the communication unit 23, the sensor unit 24, the display unit 25, and the input unit 26 have functions equivalent to those of the functional blocks of the same names in the above-described onboard navigation device 10. That is, each functional block of the mobile terminal 20 is described by replacing a phrase of the “onboard navigation device 10” in description of the onboard navigation device 10 above with a phrase of the “mobile terminal 20”, and therefore, overlapping description thereof will be omitted.

On the other hand, the mobile terminal 20 is different from the onboard navigation device 10 in, e.g., the mobile terminal 20 including the close range communication unit 27, and therefore, these differences will be described below.

The close range communication unit 27 is a component that performs wireless near field communication in accordance with a standard such as near field communication (NFC) or Bluetooth (registered trademark) or wired near field communication via, e.g., a universal serial bus (USB) cable.

The vehicle 60b includes a close range communication unit that performs communication with the close range communication unit 27. For example, an electronic control unit (ECU) of the vehicle 60b includes the close range communication unit.

A case where the mobile terminal 20 can communicate with the ECU via close range communication is, i.e., a case where the mobile terminal 20 is present inside the vehicle 60b. In this case, location information measured by the sensor unit 24 of the mobile terminal 20 is equivalent to location information on the vehicle 60b.

The mobile terminal 20 starts a location information transmission unit 212 while performing close range communication with the ECU via the close range communication unit 27. As in the location information transmission unit 112 of the onboard navigation device 10, the started location information transmission unit 212 transmits, to the future evaluation device 30, location information 221 measured by the sensor unit 24 for specifying the movement route of the vehicle 60b and moving vehicle identification information 222.

For example, when the user gets on the vehicle 60b with carrying the mobile terminal 20 and turns on a start switch, such as an ignition switch, of the vehicle 60b, the vehicle 60b and the mobile terminal 20 are connected (paired) to each other, and the measured location information 221 and the moving vehicle identification information 222 in the mobile terminal 20 are transmitted from the mobile terminal 20 to the future evaluation device 30 (FCD collecting unit 310). In this case, a location specified from the location information 221 measured immediately after pairing of the vehicle 60b and the mobile terminal 20 may be transmitted as an initial vehicle location, i.e., a departure location, to the future evaluation device 30 (FCD collecting unit 310).

When the start switch, such as the ignition switch, of the vehicle 60b is turned off, the vehicle 60b and the mobile terminal 20 are unpaired from each other. In this case, a location specified from the location information 221 measured immediately before unpairing may be transmitted as a final vehicle location, i.e., a parking location, to the future evaluation device 30 (FCD collecting unit 310).

In this case, the location information transmission unit 212 is similar to the location information transmission unit 112 in that the information may be transmitted in real time or by the burst transmission, the burst transmission may be switched to the real-time transmission when it is determined that the vehicle has arrived at the parking location, start information indicating the departure location or stop information indicating the parking location may be added, and the parking location may be transmitted upon re-start.

Note that in a case where the vehicle 60b has a function of measuring the location information, not the location information measured by the sensor unit 24 but the location information measured by the vehicle 60b may be transmitted as the location information 221 to the future evaluation device 30 (FCD collecting unit 310). In this case, the sensor unit 24 may be omitted from the mobile terminal 20.

### <Functional Blocks Included in User Terminal 40>

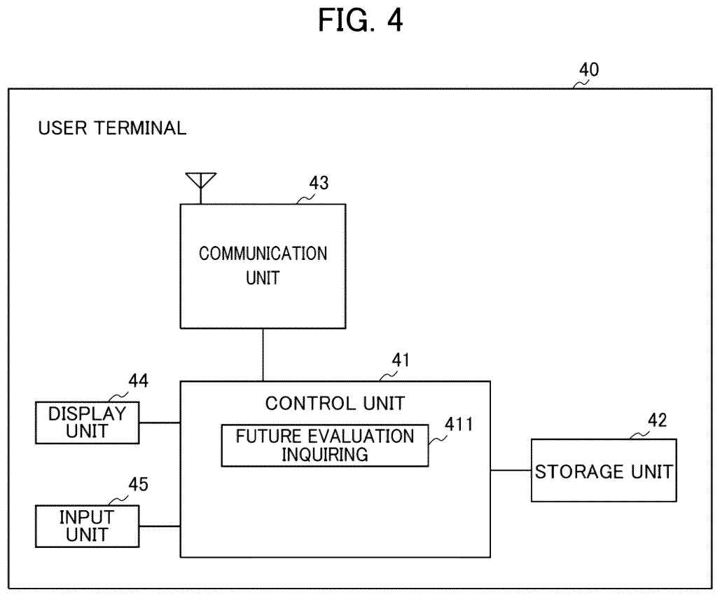

Next, functional blocks included in the user terminal 40 will be described with reference to a block diagram of FIG. 4.

As shown in FIG. 4, the user terminal 40 includes at least a control unit 41, a storage unit 42, a communication unit 43, a display unit 44, and an input unit 45. The configuration of each component is similar to that of the component of the same name in the onboard navigation device 10 or the mobile terminal 20. The user terminal 40 can be implemented by a general personal computer, and for this reason, detailed description thereof will be omitted.

The control unit 41 includes a future evaluation inquiring unit 411. The future evaluation inquiring unit 411 can access the future evaluation device 30 via a user ID assigned to a person having authority to make an inquiry about the moving vehicle parking data on a facility, which includes, e.g., a service office of a company, specified by the user.

The future evaluation inquiring unit 411 may request the future evaluation device 30 for, for example, the predictive index information on the future of a facility, such as a particular company entity, specified by the user, thereby acquiring and making an inquiry about the predictive index information on the future of the particular company entity.

Similarly, the future evaluation inquiring unit 411 may request the future evaluation device 30 for, for example, the predictive index information on the future of a particular business category specified by the user, thereby acquiring and making an inquiry about the predictive index information on the future of the particular business category.

Note that the future evaluation device 30 may have the functions of the user terminal 40.

### <Functional Blocks Included in Future Evaluation Device 30>

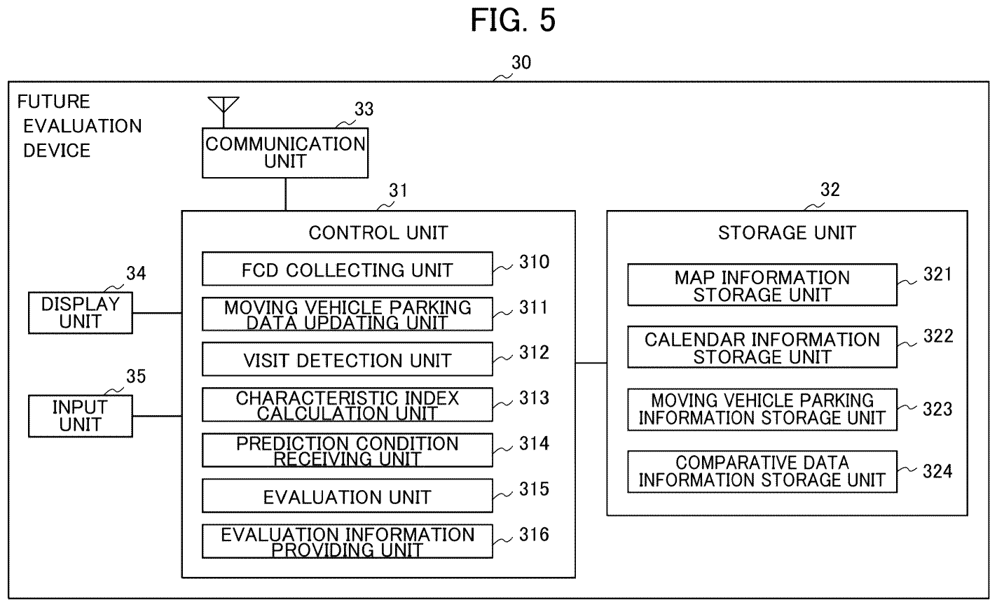

Next, functional blocks included in the future evaluation device 30 will be described with reference to a block diagram of FIG. 5.

As shown in FIG. 5, the future evaluation device 30 includes a control unit 31, a storage unit 32, and a communication unit 33.

The control unit 31 includes an arithmetic processing device such as a microprocessor, and controls each component forming the future evaluation device 30. Details of the control unit 31 will be described later.

The storage unit 32 includes, e.g., a semiconductor memory, and stores each program such as a control program called firmware or an operating system and a program for performing future evaluation analysis processing of predicting the future of a facility and various other types of information such as map information. Thus, as shown in FIG. 5, the storage unit 32 includes storages such as the map information storage unit 321, a calendar information storage unit 322, a moving vehicle parking information storage unit 323, and a comparative data information storage unit 324.

Note that in the storage unit 32, these storages may be separately or integrally included.

The map information storage unit 321 stores information such as information on a feature such as a road or a facility including, e.g., a company entity, road information, facility information, and parking information. In addition, the map information storage unit 321 also stores, for example, display map data for displaying a background such as a road and a road map, location information and category information on a node (e.g., a road intersection, bend, or end), location information and category information on a link which is a route connecting nodes, and link cost data on cost information (e.g., distance and required time) on all links.

The road information to be saved includes so-called road map information such as the location and shape of a road, the category of a road, and the location of a traffic light.

The facility information to be saved includes, as latitude-longitude information, location information on each facility including, e.g., a company entity. Further, the facility information may include additional information such as identification information (facility ID) on a facility including, e.g., a company entity, a name, category information indicating the category of a facility including, e.g., a company entity, a telephone number, an address, and business hours.

The parking information to be saved includes, as latitude-longitude information, location information on a parking area. In a case where the parking area is a parking area of each facility, the facility and the parking area are saved in association with each other.

Various types of information in the map information storage unit 321 as described above may be stored in advance, or may be downloaded as necessary from, e.g., a server device (not shown) connected to the communication network 50. Alternatively, the information may be corrected as necessary according to, e.g., user input.

The calendar information storage unit 322 stores, for example, calendar information on several previous years. With this configuration, a visit detection unit 312 or a characteristic index calculation unit 313 can set the first predetermined period and the second predetermined period corresponding to a facility specified by the user based on the calendar information on such a facility, as described later.

As described later, in a case where future corporate performance of a particular business category is predicted, the visit detection unit 312 or the characteristic index calculation unit 313 can also set the first predetermined period and the second predetermined period for each facility falling into the particular business category based on the calendar information.

The moving vehicle parking information storage unit 323 stores the moving vehicle parking data built based on the location information 121, the location information 221, the moving vehicle identification information 122, and the moving vehicle identification information 222 received from the onboard navigation device 10 and the mobile terminal 20. The moving vehicle parking data in the moving vehicle parking information storage unit 323 is built by a later-described moving vehicle parking data updating unit 311, and will be described later in description of the moving vehicle parking data updating unit 311. Note that in description below, when the location information 121 and the location information 221 are not distinguished from each other in description, such information will be referred to as “location information” with no reference numeral. Similarly, when the moving vehicle identification information 122 and the moving vehicle identification information 222 are not distinguished from each other in description, such information will be referred to as “moving vehicle identification information” with no reference numeral.

The comparative data information storage unit 324 stores, as comparative data information, the number of vehicles 60 (number of visits) having previously (in the second predetermined period) visited a facility different from the departure facility of the vehicle 60 according to the category of departure facility based on the moving vehicle parking data in the moving vehicle parking information storage unit 323. The comparative data information is calculated by the later-described characteristic index calculation unit 313, and will be described later in description of the characteristic index calculation unit 313.

The communication unit 33 has, e.g., a DSP, and implements wireless communication with other devices via the communication network 50 in accordance with a communication standard which is LTE, 4G, 5G, or Wi-Fi (registered trademark). The communication unit 33 is used, for example, for receiving the location information and the moving vehicle identification information transmitted from the onboard navigation device 10 and the mobile terminal 20.

Note that the data to be exchanged between the communication unit 33 and the other devices is not particularly limited and information other than these types of information may be exchanged.

Next, the details of the control unit 31 will be described. The control unit 31 includes a microprocessor having, e.g., a CPU, a RAM, a ROM, and an I/O. The CPU executes each program read from the ROM or the storage unit 32. Upon such execution, the CPU reads information from the RAM, the ROM, and the storage unit 32, writes information in the RAM and the storage unit 32, and exchanges a signal with the communication unit 33, a display unit 34, and an input unit 35. In this manner, the processing in the present embodiment is implemented by cooperation of hardware and software (program).

The control unit 31 includes, as functional blocks, the FCD collecting unit 310, the moving vehicle parking data updating unit 311, the visit detection unit 312, the characteristic index calculation unit 313, a prediction condition receiving unit 314, an evaluation unit 315, and an evaluation information providing unit 316.

As described above, the FCD collecting unit 310 receives and collects the FCD which is the moving vehicle location information collected from, e.g., the onboard navigation device 10 and the mobile terminal 20. Based on the location information received from the onboard navigation device 10 and the mobile terminal 20, the FCD collecting unit 310 may create and update, for each piece of identification information on the vehicle 60, traveling history data according to the order of movement, the traveling history data including, as attributes, departure location information including a departure location and a departure time, arrival location information including an arrival location and an arrival time, and movement route information.

Here, the “departure location information” in the traveling history data is information for the user to specify the departure location and departure time of the vehicle 60. Moreover, the arrival location information in the traveling history data is information for the user to specify the arrival location and arrival time of the vehicle 60.

FCD collection is a technique (see, e.g., WO 2019/082826 and WO 2019/065349) well-known by those skilled in the art, and detailed description thereof will be omitted.

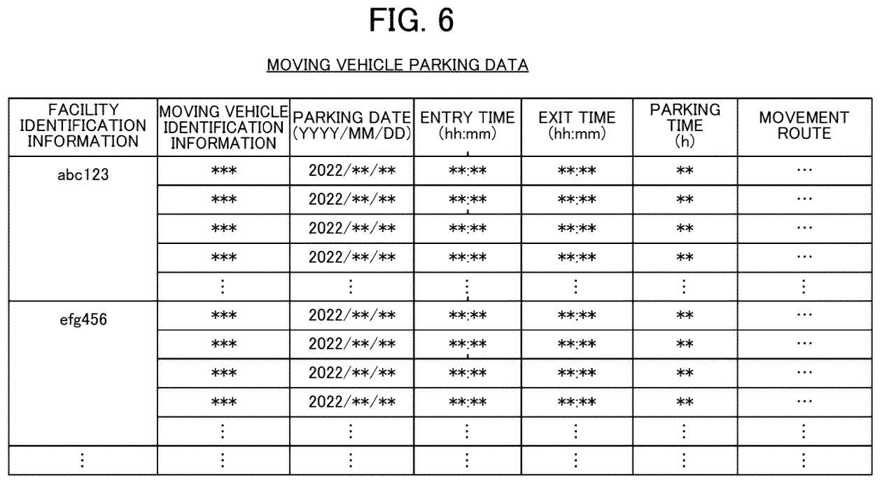

The moving vehicle parking data updating unit 311 is a component that builds the moving vehicle parking data in the moving vehicle parking information storage unit 323 and updates such moving vehicle parking data as necessary based on the traveling history data collected by the FCD collecting unit 310. One example of a data structure of the moving vehicle parking data will be described with reference to FIG. 6. FIG. 6 is a view showing one example of the data structure of the moving vehicle parking data.

As described above, the moving vehicle parking information storage unit 323 stores the moving vehicle parking data on parking of the vehicle 60 at each facility including, e.g., a company entity. Specifically, the moving vehicle parking data includes “facility identification information” for identifying a facility, which includes, e.g., a company entity, to which the vehicle 60 has visited. Moreover, the moving vehicle parking data includes “moving vehicle identification information” received from the onboard navigation device 10 and the mobile terminal 20 in the vehicles 60 parked at a parking area of a facility, which includes, e.g., a company entity, corresponding to the facility identification information. Further, the moving vehicle parking data includes “parking date-and-time information” and “movement route information” specified by the moving vehicle parking data updating unit 311 based on the “location information” received from the onboard navigation device 10 and the mobile terminal 20 in the vehicles 60 parked at a parking area of a facility, which includes, e.g., a company entity, corresponding to the facility identification information.

The moving vehicle parking data updating unit 311 saves each piece of information in a corresponding field in the moving vehicle parking data, thereby building and updating the moving vehicle parking data.

The “facility identification information” in the moving vehicle parking data is information for identifying a facility including, e.g., a company entity, and is acquired from the above-described facility information in the map information storage unit 321. The facility identification information to be used may include, for example, a number or alphabet uniquely assigned to a facility including, e.g., a company entity, a facility name, and a facility telephone number.

The “moving vehicle identification information” in the moving vehicle parking data is information for identifying the onboard navigation device 10 or the mobile terminal 20 which is the source of the location information as described above. That is, the moving vehicle identification information is information for identifying the vehicle 60 corresponding to the onboard navigation device 10 or the mobile terminal 20.

The “parking date-and-time information” in the moving vehicle parking data is information on the date and time of movement of the vehicle 60 corresponding to the moving vehicle identification information. Specifically, the parking date-and-time information may include, for example, the date (YYYY/MM/DD) of parking of the moving vehicle 60 at a parking area of a facility, the entry time (hh:mm) at which the moving vehicle 60 has arrived the parking area of the facility, the exit time (hh:mm) at which the moving vehicle 60 has left the parking area of the facility, and the parking time of the moving vehicle 60.

The “movement route” in the moving vehicle parking data may include, for example, information indicating a movement route specified based on time-discretely changing location information received during movement until the moving vehicle 60 arrives a facility after the moving vehicle 60 has left the facility. Note that in a case where the accuracy of the location information is low in an environment where the present embodiment is implemented, the moving vehicle parking data updating unit 311 may specify the movement route by map matching of checking the location information against the information in the map information storage unit 321. Note that in a case where the accuracy of the location information is high, the map matching is not necessarily performed.

The moving vehicle parking data updating unit 311 saves each piece of information described above in a new field based on the received location information and moving vehicle identification information to update the moving vehicle parking data every time transmission of the location information and the moving vehicle identification information from any of the onboard navigation device 10 and the mobile terminal 20 ends after having started once.

The moving vehicle parking data updating unit 311 needs to specify which one of the vehicles 60 has parked at a parking area and at which one of parking areas of facilities the vehicle 60 has parked when building and updating the moving vehicle parking data.

Thus, the moving vehicle parking data updating unit 311 specifies, from the received location information, the departure location of the user on the vehicle 60 and the parking location of the vehicle 60. For example, if the location information includes the information indicating the departure location and the parking location as described above, the moving vehicle parking data updating unit 311 specifies the departure location and the parking location from such information. If the location information does not include the information indicating the departure location and the parking location, the moving vehicle parking data updating unit 311 may take, as the departure location, a location corresponding to the location information first received until transmission of the location information ends after the start thereof, and take, as the parking location, a location corresponding to the location information received last or a location which does not change for a certain period of time, for example.

Then, the moving vehicle parking data updating unit 311 compares the specified departure and parking locations with the location of each facility included in the map information storage unit 321 (and the location of a parking area associated with the facility), and in a case where the specified departure or parking location matches the location of any of the facilities (and the location of the parking area associated with the facility), determines the facility having matched the departure location as the departure facility of the vehicle 60 and determines the facility having matched the parking location as the facility to which the vehicle 60 has visited. The location information corresponding to the parking location on such an outward route is determined as being received before such location information is actually received. Note that the degree of “matching” of the departure or parking location with the location of the facility may be arbitrarily set. For example, in a case where the onboard navigation device 10 or the mobile terminal 20 can accurately measure the location information, a range determined as matched may be narrowed. On the other hand, in a case where the onboard navigation device 10 or the mobile terminal 20 cannot accurately measure the location information, the range determined as matched may be expanded. That is, even in a case where the location is shifted to some extent, such a location may be determined as matched.

Note that the user of the future evaluation device 30 may correct the moving vehicle parking data as necessary.

### <Visit Detection Unit 312>

The visit detection unit 312 detects, based on a user-specified facility specified by the user and the first predetermined period among prediction conditions received from the user terminal 40 via the later-described prediction condition receiving unit 314 on the basis of the moving vehicle parking data in the moving vehicle parking information storage unit 323, whether or not the moving vehicle 60 parked at a parking area of the user-specified facility in the first predetermined period falls into the category of a visit to the user-specified facility.

Here, the prediction conditions received from the user terminal 40 include, for example, the user-specified facility specified by the user, targeted for calculation of the predictive index information on the future, and including, e.g., a company entity, the first predetermined period (e.g., one month of November, 2022) specified by the user, and the second predetermined period (e.g., one month of October, 2022 or November, 2021) different from the first predetermined period.

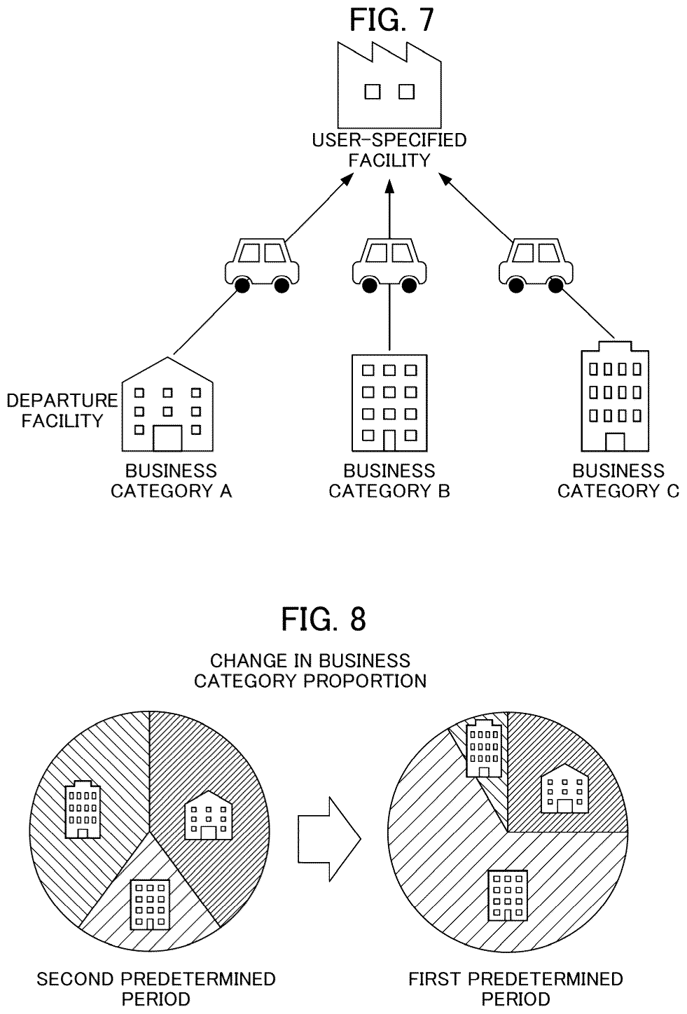

For example, as shown in FIG. 7, in a case where the first location information on the movement route of the vehicle 60 in the moving vehicle parking data, i.e., the departure location of the vehicle 60, matches the location information on a facility (departure facility) different from the user-specified facility based on the facility information in the map information storage unit 321, the visit detection unit 312 may determine that the vehicle 60 visits the user-specified facility, thereby detecting whether or not parking of the moving vehicle 60 falls into the category of the visit to the user-specified facility.

With this configuration, the visit detection unit 312 can detect the departure facility of each of the vehicles 60 which are a plurality of moving objects and the visit of each vehicle 60 to the user-specified facility in the first predetermined period specified by the user.

### <Characteristic Index Calculation Unit 313>

The characteristic index calculation unit 313 calculates, for each category of departure facility of the vehicle 60, a facility characteristic index including the number of vehicles 60 having visited the user-specified facility specified by the user (i.e., the number of visits to the user-specified facility) in the first predetermined period (e.g., one month of November, 2022) specified by the user among the prediction conditions received from the user terminal 40 via the prediction condition receiving unit 314.

Here, the facility characteristic index means various indices which can be calculated based on the facility information in the map information storage unit 321 and the moving vehicle parking data in the moving vehicle parking information storage unit 323. Specifically, the facility characteristic index includes, for example, the number of visits of a moving vehicle having visited the user-specified facility in the first predetermined period specified by the user according to the category of departure facility.

As described later, the facility characteristic index is an index for evaluating the future of the user-specified facility specified by the user and including a company entity. Note that the facility characteristic index is not limited to the above-described indices. For the characteristic index calculation unit 313, arbitrary characteristic information may be employed, which can be calculated based on the facility information in the map information storage unit 321 and the moving vehicle parking data in the moving vehicle parking information storage unit 323.

The characteristic index calculation unit 313 stores, as facility characteristic information (comparative data information) for each category of departure facility in the second predetermined period, the calculated facility characteristic index for each category of departure facility in the first predetermined period in association with the user-specified facility in the comparative data information storage unit 324.

### <Prediction Condition Receiving Unit 314>

The prediction condition receiving unit 314 receives the above-described prediction conditions from the user terminal 40 via the communication network 50, for example. The prediction condition receiving unit 314 may generate a user interface for receiving the input of the prediction conditions from the user, and cause the user terminal 40 to display the generated user interface. With this configuration, the user can input the prediction conditions with reference to the user interface.

For example, the user specifies a facility targeted for evaluation via the user terminal 40, such as specifying the first predetermined period (e.g., one month of November, 2022) and the second predetermined period (e.g., one month of October, 2022 or November, 2021) based on the calendar information in the calendar information storage unit 322 or inputting a condition for the number of visits of the moving vehicle. Accordingly, as described above, the characteristic index calculation unit 313 can refer to the moving vehicle parking data on the moving vehicle having visited the user-specified facility, thereby counting and calculating the number of visits in the first predetermined period indicated by the calendar information according to the category of departure facility. The evaluation unit 315 can create the predictive index information on the future of the user-specified facility from the proportion change based on comparison between the calculated facility characteristic information in the first predetermined period and the facility characteristic index of the second predetermined period read from the comparative data information storage unit 324 (here, the number of visits in the first predetermined period and the number of visits in the second predetermined period).

The user may specify, as an evaluation target, a particular business category instead of specifying a particular facility. In this case, the visit detection unit 312 may extract a plurality of facilities falling into the particular business category, and the characteristic index calculation unit 313 may calculate the facility characteristic index for each facility and calculate a characteristic index (e.g., average, maximum value, minimum value, intermediate value, or sum) for the particular business category based on the facility characteristic index calculated for each facility.

### <Evaluation Unit 315>

The evaluation unit 315 creates the predictive index information on the future of a company entity which is the user-specified facility from the proportion change based on comparison between the facility characteristic index of the user-specified facility calculated for the first predetermined period by the characteristic index calculation unit 313 and the facility characteristic index for the second predetermined period from the comparative data information storage unit 324.

Here, the predictive index information is information indicating positive, negative, or neutral.

FIG. 8 is a view showing one example of the predictive index information. FIG. 8 shows predictive index information display data created in a display form comparable based on the proportion change of the category information on the departure facility.

As shown in FIG. 8, in a case where the user-specified facility is a manufacturer such as an automobile assembly factory and a “business category B” is a component manufacturer that delivers, e.g., a semiconductor component to the facility, the evaluation unit 315 may determine that production in the user-specified facility is prosperous because the proportion of the number of visits has increased in the first predetermined period than in the second predetermined period, and therefore, may determine the future as positive. Conversely, the evaluation unit 315 may determine the future as negative in a case where the number of visits of the “business category B” to the user-specified facility in the first predetermined period has decreased as compared to the second predetermined period. In neither case, the evaluation unit 315 may determine the future as neutral.

In a case where a “business category C” is, e.g., a financial facility, if the number of visits has decreased in the first predetermined period as compared to the second predetermined period, the evaluation unit 315 may determine that the corporate performance of the user-specified facility is prosperous and determine the future as positive. Conversely, in a case where the number of visits of the “business category C” to the user-specified facility in the first predetermined period has increased as compared to the second predetermined period, the evaluation unit 315 may determine the future as negative. In neither case, the evaluation unit 315 may determine the future as neutral.

With this configuration, the number of visits according to the category of departure facility is clarified from the proportion change based on comparison between the number of visits in the first predetermined period according to the category of departure facility and the number of visits in the previous second predetermined period according to the category of departure facility, and therefore, the future evaluation device 30 can predict the future of, e.g., a specified company using only objective and observable data.

Moreover, for example, the number of visits to the user-specified facility according to the category of departure facility can be compared in the same period between a current year and a previous year, and therefore, the future evaluation device 30 can predict the future of, e.g., a specified company using only objective and observable data.

Note that in a case where the category information on the departure facility does not include information on the business category, the evaluation unit 315 may determine the facility as a residence and not use such information for creation of the predictive index information.

With this configuration, a vehicle used by a commuter can be excluded, and therefore, the future evaluation device 30 can more accurately predict the future of, e.g., a company.

The case where the evaluation unit 315 creates the predictive index information on the future of a specified facility has been described above, but as described above, the evaluation unit 315 may create the predictive index information on the future of a particular business category (particular business field).

Processing in this case will be briefly described.

Hereinafter, it is assumed that a user-specified facility specified by the user is a plurality of facilities (j) (1≤j≤M) falling into a particular business category. Here, M indicates the number of user-specified facilities which are company entities falling into the particular business category specified by the user.

First, the visit detection unit 312 detects, for each facility (j) falling into the particular business category specified by the user, the departure facility of each vehicle 60 having visited the facility (j) in the first predetermined period specified by the user.

For each facility (j), the characteristic index calculation unit 313 calculates, for each category (k) (1≤k≤P) of departure facility, a facility characteristic index (j, k) including the number of vehicles 60 having visited the facility (j) (i.e., the number of visits to the facility (j)) in the first predetermined period. Here, P indicates the number of categories of departure facility.

Hereinafter, the number of vehicles 60 having visited the facility (j) in the first predetermined period according to the category (k) of departure facility is indicated by N₁(j, k), and the number of vehicles 60 having visited the facility (j) in the second predetermined period according to the category (k) of departure facility in the comparative data information storage unit 324 is indicated by N₂(j, k).

The evaluation unit 315 can create the predictive index information on the future of the particular business category (particular business field) from the proportion change based on comparison between a first group {N₁(j, k): 1≤j≤M, 1≤k≤P} and a second group {N₂(j, k): 1≤j≤M, 1≤k≤P}.

Note that upon comparison between the first group {N₁(j, k): 1≤j≤M, 1≤k≤P} and the second group {N₂(j, k): 1≤j≤M, 1≤k≤P}, the average of the first group and the average of the second group may be compared with each other as described above, for example. Alternatively, the sum of the first group and the sum of the second group may be compared with each other. The present invention is not limited to above, and arbitrary statistical values (e.g., intermediate values, maximum values, or minimum values) may be used for comparison between the groups.

With this configuration, the future of the particular business category (particular business field) can be predicted using only objective and observable data.

Note that the prediction condition receiving unit 314 may receive a particular business category into which the user-specified facility falls instead of receiving a plurality of user-specified facilities from the user. In this case, the prediction condition receiving unit 314 may select the plurality of facilities (j) falling into the particular business category based on a correspondence table (not shown) indicating a correspondence between a preset business category and the plurality of facilities (j).

### <Evaluation Information Providing Unit 316>

The evaluation information providing unit 316 provides the user terminal 40 (future evaluation inquiring unit 411) with the predictive index information determined on the future of the user-specified facility or the specified particular business category by the evaluation unit 315.

As shown in, e.g., FIG. 8, the evaluation information providing unit 316 may provide the predictive index information (e.g., positive, negative, or neutral) together with a graph showing the numbers of visits in the first predetermined period and the second predetermined period.

### Operation of Present Embodiment

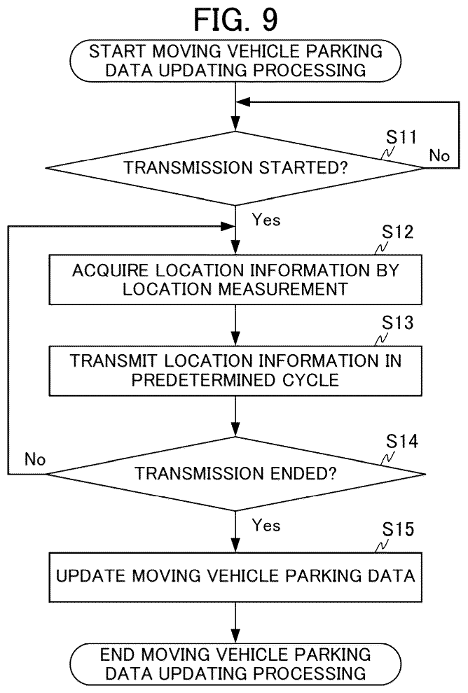

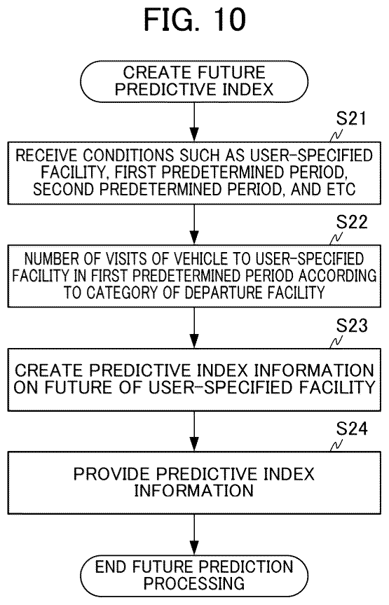

Finally, operation of the present embodiment will be described with reference to flowcharts of FIGS. 9 and 10. Here, FIG. 9 is the flowchart showing operation of collecting the location information and updating the moving vehicle parking data by the FCD collecting unit 310 and the moving vehicle parking data updating unit 311. Moreover, FIG. 10 is the flowchart showing basic operation of creating the predictive index information on the future by the visit detection unit 312, the characteristic index calculation unit 313, the prediction condition receiving unit 314, and the evaluation unit 315.

First, operation in a case where the moving vehicle parking data in the moving vehicle parking information storage unit 323 is updated using the location information collected from the onboard navigation device 10 will be described with reference to FIG. 9.

It is determined whether or not the location information transmission unit 112 starts transmitting the location information (Step S11). As described above, transmission starts when the ignition switch of the vehicle 60a is turned on. In a case where the ignition switch remains OFF (No in Step S11), transmission by the location information transmission unit 112 does not start. On the other hand, in a case where the ignition switch is ON (Yes in Step S11), the processing proceeds to Step S12.

In Step S12, the sensor unit 14 acquires the location information by measuring the location of the onboard navigation device 10 (Step S12).

The location information transmission unit 112 acquires the location information from the sensor unit 14, and transmits the acquired location information to the FCD collecting unit 310 in a predetermined cycle in real time or by the burst transmission (Step S13).

Next, it is determined whether or not the location information transmission unit 112 ends transmission of the location information (Step S14). As described above, transmission ends when the ignition switch of the vehicle 60a is turned off. In a case where the ignition switch of the vehicle 60a remains ON (No in Step S14), measurement in Step S12 and transmission in Step S13 are repeated.

On the other hand, in a case where the ignition switch of the vehicle 60a is turned off (Yes in Step S14), the processing proceeds to Step S15.

In Step S15, the moving vehicle parking data updating unit 311 of the future evaluation device 30 updates the moving vehicle parking data in the moving vehicle parking information storage unit 323 based on the location information transmitted by repetition of Step S12 and Step S13.

By operation described above, the location information is collected, and the moving vehicle parking data in the moving vehicle parking information storage unit 323 is updated.

Next, operation in a case where the moving vehicle parking data in the moving vehicle parking information storage unit 323 is updated using the location information collected from the mobile terminal 20 will be described with reference to FIG. 9. In this case, in description above with reference to FIG. 9, the location information transmission unit 112 may be replaced with the location information transmission unit 212, the sensor unit 14 may be replaced with the sensor unit 24, the criterion for determination as Yes in Step S11 may be replaced with “a case where the start switch, such as the ignition switch, of the vehicle 60b is turned on and the vehicle 60b and the mobile terminal 20 are paired with each other”, and the criterion for determination as Yes in Step S14 may be replaced with “a case where the start switch, such as the ignition switch, of the vehicle 60b is turned off and the vehicle 60b and the mobile terminal 20 are unpaired from each other”. Thus, overlapping description thereof will be omitted.

Next, basic operation when the predictive index information on the future is created will be described with reference to the flowchart of FIG. 10.

First, the prediction condition receiving unit 314 receives conditions for the facility characteristic index, for example, from the user terminal 40 via the communication network 50 (Step S21). The prediction condition receiving unit 314 outputs the received conditions to the visit detection unit 312.

The visit detection unit 312 specifies the user-specified facility based on the received conditions and the map information storage unit 321. Then, based on the moving vehicle parking data in the moving vehicle parking information storage unit 323, the characteristic index calculation unit 313 calculates, for each category of departure facility, the number of vehicles 60 having visited the user-specified facility in the first predetermined period (i.e., the number of visits to the user-specified facility) (Step S22).

The evaluation unit 315 creates the predictive index information on the future of a company entity which is the user-specified facility from the proportion change based on comparison between the number of visits, which is calculated in Step S22, to the user-specified facility in the first predetermined period according to the category of departure facility and the number of visits, which is read from the comparative data information storage unit 324, to the user-specified facility in the previous second predetermined period according to the category of departure facility (Step S23).

The evaluation information providing unit 316 transmits, via the communication network 50, the predictive index information on the future of the company entity which is the user-specified facility to the user terminal 40. The user terminal 40 displays the predictive index information on the future on the display unit 44, thereby providing such information to the user (Step S24).

According to operation of the present embodiment described above, the predictive index information on the future of the user-specified facility can be created from the proportion change based on comparison between the number of visits to the user-specified facility in the first predetermined period according to the category of departure facility and the number of visits in the second predetermined period different from the first predetermined period according to the category of departure facility, and can be provided to the user.

### <Modifications>

The above-described embodiment is a preferred embodiment of the present invention, but the scope of the present invention is not limited only to the above-described embodiment and embodiments to which various changes are made without departing from the gist of the present invention can be implemented. For example, embodiments to which changes are made as in each modification described below can be implemented.

### <First Modification>

In the above-described embodiment, the vehicle has been described as an example of the moving object, and the visit of the moving vehicle to the user-specified facility is detected based on the location information on the moving vehicle (moving vehicle transmitted from the onboard navigation device 10 or the mobile terminal 20 carried by the user). However, the present invention is not limited to above.

For example, a visitor of the user-specified facility may be applied as the moving object. Specifically, for example, in a case where the user-specified facility includes a device that records the facility (departure facility) of the visitor together with entry of the visitor to the user-specified facility and exit of the visitor from the user-specified facility, the visit detection unit 312 may detect the departure facility of the visitor visiting the user-specified facility based on visitor departure facility information data obtained from the device that records the entry and the exit.

Based on such information data, the characteristic index calculation unit 313 may calculate the number of visits to the user-specified facility in the first predetermined period according to the category of departure facility.

### <Other Modifications>

In the above-described embodiment, the future evaluation device 30 is implemented by, e.g., one server device. However, as another modification, a distributed processing system may be employed, which distributes the functions of the future evaluation device 30 to a plurality of server devices as necessary. Each function of the future evaluation device 30 may be implemented using, e.g., a virtual server function on the cloud. Instead of the user terminal 40, the future evaluation device 30 may have the functions of the user terminal 40.

That is, the functional configurations of FIGS. 2, 3, 4, and 5 are merely examples, and are not intended to limit the functional configuration of the present embodiment. That is, each type of equipment is only required to have a function of implementing a series of processing for the information analysis function of the present invention as a whole, and functional blocks to be used for implementing these functions are not limited to those of the examples of FIGS. 2, 3, 4, and 5.

Specifically, the FCD collecting unit 310 included in the future evaluation device 30 may be included, for example, in an FCD collection server (not shown). With this configuration, the future evaluation device 30 may download the FCD from the FCD collection server (not shown) as necessary.

The moving vehicle parking data updating unit 311 included in the future evaluation device 30 may be included, for example, in an FCD collection server (not shown). With this configuration, the future evaluation device 30 may download the moving vehicle parking data from the FCD collection server (not shown) as necessary.

### <Hardware and Software>

Note that each type of equipment included in the above-described navigation system can be implemented by hardware, software, or a combination thereof. Moreover, the navigation method performed by cooperation of the equipment included in the above-described navigation system can also be implemented by hardware, software, or a combination thereof.

Implementation by the software as described herein means implementation by reading and execution of a program by a computer.

The program can be stored using various types of non-transitory computer readable media and be supplied to the computer. The non-transitory computer readable media include various types of tangible storage media. Examples of the non-transitory computer readable media include magnetic recording media (e.g., a flexible disk, a magnetic tape, and a hard disk drive), magnetic optical recording media (e.g., a magnetic optical disk), a CD-read only memory (CD-ROM), a CD-R, a CD-R/W, and semiconductor memories (e.g., a mask ROM, a programmable ROM (PROM), an erasable PROM (EPROM), a flash ROM, and a random access memory (RA)). The program may be supplied to the computer by means of various types of transitory computer readable media. Examples of the transitory computer readable media include an electric signal, an optical signal, and an electromagnetic wave. The transitory computer readable medium can supply the program to the computer via a wired communication path such as an electric wire or an optical fiber or a wireless communication path.

### EXPLANATION OF REFERENCE NUMERALS

1 Future Evaluation System
10 Onboard Navigation Device
11, 21, 31 Control Unit
111, 211, Route Guiding Unit
112, 212 Location Information Transmission Unit
12, 22, 32 Storage Unit
121, 221 Location Information
122, 222 Moving Vehicle Identification Information
13, 23, 33 Communication Unit
14, 24 Sensor Unit
15, 25, 34 Display Unit
16, 26, 35 Input Unit
20 Mobile Terminal
27 Close Range Communication Unit
30 Future Evaluation Device
310 FCD Collecting Unit
311 Moving Vehicle Parking Data Updating Unit
312 Visit Detection Unit
313 Characteristic Index Calculation Unit
314 Prediction Condition Receiving Unit
315 Evaluation Unit
316 Evaluation Information Providing Unit
32 Storage Unit
321 Map Information Storage Unit
322 Calendar Information Storage Unit
323 Moving Vehicle Parking Information Storage Unit
324 Comparative Data Information Storage Unit
40 User Terminal
50 Communication Network
60 Moving Vehicle
60a, 60b Vehicle

What is claimed is:

1. A future evaluation device comprising:
a visit detection unit configured to detect departure facilities of a plurality of moving objects and a visit to a facility different from each departure facility;
a map information storage unit configured to store facility information including category information and location information on a facility;
a comparative data information storage unit configured to store, for the facility different from each departure facility, the number of previous visits of each moving object to the facility according to a category of each departure facility as comparative data information;
a prediction condition receiving unit configured to receive, as a user-specified facility, information on a facility specified by a user from the facility information; and
an evaluation unit configured to create, for a moving object having visited the user-specified facility, predictive index information on a future of the user-specified facility from a proportion change based on comparison between the number of visits according to the category of each departure facility and the comparative data information.

2. The future evaluation device according to claim 1, further comprising:
a calendar information storage unit configured to store information on a calendar,
wherein the evaluation unit create the predictive index information on the future of the user-specified facility based on comparison between the number of visits of the moving object in a first predetermined period of the calendar according to the category of each departure facility and the comparative data information in a second predetermined period different from the first predetermined period.

3. The future evaluation device according to claim 1, wherein the evaluation create predictive index information display data in a display form comparable based on a change in a proportion of the category information on each departure facility.

4. The future evaluation device according to claim 1, wherein
the category information on the facility in the map information storage unit is information on a business category, and
in a case where the category information on each departure facility includes no information on the business category, the evaluation unit determines the facility as a residence and does not use the category information for creation of the predictive index information.

5. A future evaluation method performed by a computer including a map information storage unit configured to store facility information including category information and location information on a facility, comprising:
detecting departure facilities of a plurality of moving objects and a visit to a facility different from each departure facility;
storing, for the facility different from each departure facility, the number of previous visits of each moving object to the facility according to a category of each departure facility as comparative data information;
receiving, as a user-specified facility, information on a facility specified by a user from the facility information; and
creating, for a moving object having visited the user-specified facility, predictive index information on a future of the user-specified facility from a proportion change based on comparison between the number of visits according to the category of each departure facility and the comparative data information.
